(19) United States
(12) Patent Application Publication
(10) Pub. No.: US 2020/0190358 A1
(43) Pub. Date: Jun. 18, 2020

(54) ORGANOSILOXANE COATING COMPOSITION AND USES THEREOF

(71) Applicant: Momentive Performance Materials Inc., Waterford, NY (US)

(72) Inventors: Pranav Ramchandra JOSHI, Bangalore (IN); Nrupen PATEL, Clifton Park, NY (US); Yogesh TIWARY, Bangalore (IN)

(21) Appl. No.: 16/218,751

(22) Filed: Dec. 13, 2018

(51) Int. Cl. C09D 183/04; C09D 7/40; C09D 7/62; C09D 7/65; C09D 7/80

(52) U.S. Cl. CPC C09D 183/04; C09D 7/68; C09D 7/69; C08G 77/08; C09D 7/65; C09D 7/80; C09D 7/62

(57) ABSTRACT

An organosiloxane composition and the use of such compositions is provided. The organosiloxane composition comprises (a) 20-55 wt. % of at least one polymerization-effective polymer bearing two or more silicon atoms; (b) 24-60 wt. % of a first filler of average particle size from 0.1 μm to 10 μm; (c) optionally a second filler; (d) a crosslinking agent; and (e) a catalyst. The use of the first filler having that size range and present in this amount provides improved dirt pick up resistance to films and coatings formed from the compositions.

### FIELD OF THE INVENTION

The disclosed technology relates to an organosiloxane composition comprising polymerization-effective silicone polymers and coatings formed from such compositions. More specifically the disclosed technology relates to an organosiloxane composition comprising a polymerization-effective silicone polymer and a filler of discrete particle sizes for forming coatings that exhibit desirable properties such as improved resistance to adherence of contaminant particles (e.g., dirt, soils, etc.).

### BACKGROUND

Silicone elastomeric materials are widely used to form coatings. The silicone coating enhances various characteristics such as water repellency, durability, flexibility, thermal crack resistance, and UV weatherability. These silicone elastomeric materials can be used, for example, for new as well as restored roofs, walls or as architectural coatings. When coating materials are mixed with certain pigments, they may offer high solar reflectivity index (SRI), which prevents absorption of solar radiation by the underlying roof and thereby reduces the cost of air conditioning. This phenomenon is known as the “cool-roof” effect.

Silicone coating materials generally have a low glass transition temperature (T_{g}), which is responsible for the coating having a softer outer surface and leads to tackiness and increased likelihood of contaminant particles (e.g., dirt, soils, etc.) adhering to the coating. This may also be referred to as “dirt pick-up.” A higher amount of dirt pick-up (i.e., a lower dirt pick-up resistance) may lead to a progressive reduction of the cool-roof effect.

The conventional way to improve dirt pick-up resistance is to raise the glass transition temperature (T_{g}) of the coating to create a harder outer surface. This, however, negatively affects the elongation of the coating. One of the challenges has therefore been obtaining an improvement in the level of hardness without compromising elongation values that are both important in a variety of coating applications, including, for example, architectural coating applications.

Other conventional ways of improving dirt pick-up resistance have included using highly cross-linked polymers to provide a low-tack surface that impedes dirt penetration. While this method is commonly used in automotive coating applications and architectural organic coatings, silicone elastomeric coatings provide unique challenges, including the need to retain a minimum level of elongation, which is reduced in the higher cross-linked systems.

Thus, there is a need for improved silicone-based elastomeric coating compositions with improved dirt pick resistance without compromising the elongation and other beneficial properties.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is an organosiloxane composition suitable for forming a coating and coated articles formed from such compositions. In aspects, the coating exhibits desirable properties such as resistance to the adherence of contaminants (e.g., dirt, soil, other particulate contaminants), which may adversely affect other properties of the coating. In particular, applicants have found that relatively large concentrations of filler materials of a discrete particle size can provide a coating that exhibits certain desired characteristics or properties in terms of hardness and elongation while being sufficiently resistant to adherence of contaminant particulate matter.

In one aspect, provided is an organosiloxane composition, comprising: a) at least one polymerization-effective polymer bearing two or more silicon atoms; b) at least one first filler having a particle size from about 0.1 μm to about 10 μm; c) optionally at least one second filler of any particle size; d) at least one crosslinking agent; and e) at least one catalyst.

In one aspect, provided is an organosiloxane composition, comprising:
a) about 20 to about 55 wt. %, based on the total weight of the composition, of at least one polymerization-effective polymer bearing two or more silicon atoms;
b) about 24 to about 60 wt. %, based on the total weight of the composition, of at least one first filler having an average particle size from about 0.1 μm to about 10 μm;
c) optionally at least one second filler;
d) at least one crosslinking agent; and
e) at least one catalyst.

In one embodiment, the polymerization-effective polymer bearing two or more silicon atoms is of the general formula (I):

M¹ₐM²_{b}M³_{c}M⁴_{d}D¹ₑD²_{f}D³_{g}D⁴ₕ (I)
wherein;
M¹=R¹R²R³SiO_{1/2}
M²=R⁴R⁵R⁶SiO_{1/2}
M³=R⁷R⁸R⁹SiO_{1/2}
M⁴=R¹⁰R¹¹R¹²SiO_{1/2}
D¹=R¹³R¹⁴SiO_{2/2}
D²=R¹⁵R¹⁶SiO_{2/2}
D³=R¹⁷R¹⁸SiO_{2/2}
D⁴=R¹⁹R²⁰SiO_{2/2}
where R¹ and R¹³ are each independently an aliphatic group having from 1 to 20 carbon atoms; an OH group; —H; or OR²⁵ where R²⁵ is an aliphatic group or an aromatic group having from 1 to 20 carbon atoms;
R², R³, R⁵, R⁶, R⁸, R⁹, R¹⁰ R¹¹, R¹², R¹⁴, R¹⁶, R¹⁸, R¹⁹ and R²⁰ are each independently an aliphatic group having from 1 to 20 carbon atoms; or an aromatic group having from 6 to 30 carbon atoms;
R⁴ and R¹⁵ are each independently of the formula:

—(CₙH₂ₙ)—O—(C₂H₄O)ₒ—(C₃H₆O)ₚ—(C₄H₈O)_{q}—R²⁶,
wherein R²⁶ is a hydrogen or an aliphatic group, or an aromatic group having from 1 to 20 carbon atoms;
n is 0 to 6;
o is 0 to 100;
p is 0 to 100;
q is 0 to 50;
o+p+q≥0, more specifically provided o+p+q≥40, even more preferably o+p+q≥18 and most preferably o+p+q≥8;
R⁷ and R¹⁷ are each independently a branched, linear, or cyclic alkyl group, optionally saturated or unsaturated, having from 1 to 20 carbon atoms, and the subscripts a, b, c, d, e, f, g and h are each independently zero or a positive integer, and provided that a+b+c+d+e+f+g+h≥2;
a+b+c+d=2; and
a+e≥2.

In one embodiment, the polymer of formula (I) contains at least one group chosen from —OH, OR²⁵ or combinations thereof.

In one embodiment of the organsiloxane composition of any previous embodiment, the at least one first filler is selected from the group consisting of treated or untreated clays, nano-clays, organo-clays, grounded calcium carbonate, precipitated calcium carbonate, colloidal calcium carbonate, treated calcium, silanes, talc, mica, pumice, wollastonite, dolomite, feldspar, nepheline syenite, barite, diatomite, calcite and combinations thereof.

In one embodiment of the organsiloxane composition of any previous embodiment, the at least one first filler is untreated calcium carbonate or a treated calcium carbonate.

In one embodiment of the organsiloxane composition of any previous embodiment, the first filler has an average particle size from about 0.1 μm to about 10 μm, from about 1 μm to about 8 μm, from about 2 μm to about 6 μm, or from about 2.5 μm to about 5 μm.

In one embodiment of the organsiloxane composition of any previous embodiment, the first filler is present in the composition in an amount of from about 24 wt. % to about 60 wt. % based on the total weight of the composition, from about 30 wt. % to about 50 wt. %, or from about 35 wt. % to about 45 wt. % based on the total weight of the composition.

In one embodiment of the organsiloxane composition of any previous embodiment, the first filler comprises:
a treated filler material (i) having a particle size of from about 0.1 μm to about 10 μm; preferably from about 1 μm to about 8 μm; or about ≤5 μm; and
an untreated filler (ii) having a particle size of from about 0.1 μm to about 10 μm; preferably from about 1 μm to about 8 μm; or about ≤5 μm.

In one embodiment of the organsiloxane composition of any previous embodiment, the optional at least one second filler is selected from the group consisting of treated or untreated clays, nano-clays, organo-clays, grounded calcium carbonate, precipitated calcium carbonate, colloidal calcium carbonate, treated calcium carbonate, talc, mica, pumice, wollastonite, dolomite, feldspar, nepheline syenite, barite, diatomite, calcite, fumed silica, precipitated silica, crushed quartz, ground quartz, alumina, aluminum hydroxide, ceramic and glass spheres, silicone resins, titanium dioxide, titanium hydroxide, hydroxide, kaolin, bentonite montmorillonite, diatomaceous earth, iron oxide, carbon black and graphite and combinations thereof.

In one embodiment of the organsiloxane composition of any previous embodiment, the at least one catalyst is a metal condensation catalyst wherein the metal is selected from the group consisting of tin, titanium, zirconium, lead, iron cobalt, antimony, manganese, bismuth and zinc compounds.

In one embodiment of the organsiloxane composition of any previous embodiment, the at least one catalyst is selected from the group consisting of dibutyltindilaurate, dibutyltindiacetate, dibutyltindimethoxide, tinoctoate, isobutyltintriceroate, dibutyltinoxide, solubilized dibutyl tin oxide, dibutyltin bis-diisooctylphthalate, 7. 1,3-propanedioxytitanium bis(ethylacetoacetate), di-isopropoxytitanium bis(ethylacetoacetate), tetra n-butyl titanate, tetraisopropyl titanate, di-isopropyl titanium bisacetylacetonate, bis-tripropoxysilyl dioctyltin, dibutyltin bis-acetylacetone, silylated dibutyltin dioxide, carbomethoxyphenyl tin trisuberate, isobutyltin triceroate, dimethyltin dibutyrate, dimethyltin di-neodecanoate, triethyltin tartarate, dibutyltin dibenzoate, tin oleate, tin naphthenate, butyltintri-2-ethylhexylhexoate, and tin butyrate, combinations thereof.

In one embodiment of the organsiloxane composition of any previous embodiment, the catalyst is selected from the group consisting of 1,3-propanedioxytitanium bis(ethylacetoacetate), di-isopropoxytitanium bis(ethylacetoacetate), tetra n-butyl titanate, tetraisopropyl titanate, di-isopropyl titanium bisacetylacetonate and combinations thereof.

In one embodiment of the organsiloxane composition of any previous embodiment, the at least one crosslinking agent is of general formula (II):

(R^{A})_{x″}R^{B}_{y″}Si (II)

wherein, R^{A} is independently chosen from hydrogen or an alkoxy group and R^{B} is independently chosen from a monovalent C1 to C60 hydrocarbon radical, an epoxy group, a mercapto group, an acrylate group, a methacryloxy group, a vinyl group, an isocyanato group, an isocyanurate group, a carboxy group, an alkylthiocarboxylate group, an ureido group, a polyalkylene oxide group, an amino group, an amido group, a urea group having from 1 to 60 carbon atoms, and wherein x″ is from 2 to 4 and y″ is from 0 to 2, provided that x″+y″=4.

In one embodiment of the organsiloxane composition of any previous embodiment, the at least one crosslinking agent is selected from the group consisting of isocyanato silane, N-(beta-aminoethyl)-γ-aminopropyltrimethoxysilane, N-ethyl-γaminoisobutyl trimethoxysilane, Bis-[γ-(trimethoxysilyl)propyl]amine, n-2-aminoethyl-3-aminopropyltri-methoxysilane, 1,3,5-tris(trimethoxy silylpropyl)isocyanurate, γ-aminopropyltriethoxysilane, γ-aminopropyltrimethoxysilane, aminopropyltrimethoxy-silane, bis-γ-trimethoxysilylpropyl)amine, N-Phenyl-γ-aminopropyltrimethoxysilane, triaminofunctionaltrimethoxysilane, γ-aminopropyl-methyldiethoxysilane, γ-aminopropylmethyldiethoxysilane, methacryloxypropyltrimethoxy-silane, methylamino-propyltrimethoxysilane, γ-glycidoxypropylethyldimethoxysilane, γ-glycidoxypropyl-trimethoxysilane, γ-glycidoxyethyltrimethoxysilane, beta-(3,4-γepoxycyclohexyl)propyl-trimethoxysilane, beta-(3,4-epoxycyclohexyl)ethylmethyl-dimethoxy-silane, isocyanato-propyltriethoxysilane, isocyanatopropylmethyl-dimethoxysilane, beta-cyanoethyl-trimethoxysilane, γ-acryloxypropyltrimethoxysilane, γ-methacryloxypropylmethyl-dimethoxysilane, 4-amino-3,3-dimethylbutyltrimethoxy-silane, n-ethyl-3-trimethoxysilyl-2-methylpropanamine and Tris[3-(trimethoxysilyl)propyl] isocyanurate.

In one embodiment of the organsiloxane composition of any previous embodiment, the composition further comprises one or more additives selected from the group consisting of pigments, biocides, processing aids, surfactants, preservatives, flow and levelling agents, microbicides, fungicides, algicides, nematicides, molluscicides, matting agents, organic polymer particles, thixotropic additives, waxes, flame retardants, anti-stat agent, anti-sag agents, solvents, adhesion promoters and combinations thereof.

In one embodiment of the organsiloxane composition of any previous embodiment, wherein one or more additives are selected from the group consisting of Bis(trifluoromethanesulfonimide) salt, PTFE particles, titanium dioxide, silicon dioxide, PTFE, polyamides, polyolefins, silicone polyether, silicone polyesters, fluoropolyethers, fluoropolyester, fluorosilicones, polyacrylates, silicone acrylates, or combination thereof.

In another aspect, provided is an article comprising the organosiloxane composition of any of the previous embodiments disposed on at least a portion of a surface of the article.

In one embodiment, the composition is cured to form a coating, sealant, caulk, seam sealant, or adhesive material

In one embodiment, the composition provides a roof coating, an architectural coating, a marine coating.

In one embodiment, the composition provides a anti-dirt coating, anti-stain coating, anti-fouling coating, an anti-corrosion coating, or a protective coating.

In another aspect, provided is a process for forming a coating from the organosiloxane composition of any the previous embodiments comprising: (i) mixing the at least one polymerization-effective polymer (a) with the filler (b) and optional filler (c); (ii) mixing the at least one crosslinking agent (d) and at least one catalyst (e) with the mixture of (i); and (iii) curing the mixture from (ii) to form a coating.

In one embodiment, the process is a batch process. In one embodiment, the process is conducted via an extrusion process.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 depicts extrusion process of coating composition; and

FIG. 2 depicts results of anti-stat additive on coating formulation of the invention.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The present invention may be understood more readily by reference to the following detailed description of preferred embodiments of the invention and the examples included therein. In the following specification and the claims which follow, reference will be made to a number of terms which shall be defined to have the following meanings.

The singular forms “a,” “an” and “the” include the plural, and reference to a particular numerical value includes at least that particular value unless the context clearly dictates otherwise.

As used herein the term “aromatic” refers to a compound having a valence of at least one and comprising at least one aromatic ring. The term includes groups containing both aromatic and aliphatic components, for example a benzyl group, a phenethyl group or a naphthylmethyl group. The term also includes groups comprising both aromatic and cycloaliphatic groups for example 4-cyclopropylphenyl and 1,2,3,4-tetrahydronaphthalen-1-yl.

The term “alkylene” as used in the various embodiments of the present invention is intended to designate both normal alkylene, branched alkylene, aralkylene, and cycloalkylene compounds.

Other than in the working examples or where otherwise indicated, all numbers expressing amounts of materials, reaction conditions, time durations, quantified properties of materials, and so forth, stated in the specification and claims are to be understood as being modified in all instances by the term “about.” It will be understood that any numerical range recited herein includes all sub-ranges within that range and any combination of the various endpoints of such ranges or sub-ranges.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. The modifier “about” used in connection with a quantity is inclusive of the stated value, and has the meaning dictated by context, (e.g., includes the degree of error associated with measurement of the particular quantity). Accordingly, a value modified by a term or terms, such as “about,” is not limited to the precise value specified. In some instances, the approximating language may correspond to the precision of an instrument for measuring the value.

No language in the specification should be construed as indicating any non-claimed element as essential to the practice of the invention.

As used herein, the terms “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

The terms “first,” “second,” and the like, herein do not denote any order, quantity, or importance, but rather are used to distinguish one element from another and intended for the purpose of orienting the reader as to specific components parts.

Composition percentages are given in weight percent unless otherwise indicated.

It will be further understood that any compound, material, or substance that is expressly or implicitly disclosed in the specification and/or recited in a claim as belonging to a group of structurally, compositionally, and/or functionally related compounds, materials or substances includes individual representatives of the group and all combinations thereof.

The term “polymerization-effective polymer” refers to a monomer or pre-polymer or oligomer or copolymer or polymer that can be polymerized or further polymerized or copolymerized.

The term coating material means a material which can form a film of finite thickness on a substrate using now known or later discovered coating and application methods.

The described technology provides an organosiloxane composition suitable for forming a coating. The coating formed from the composition may exhibit good resistance to adherence of contaminant particulate materials to the coating. In one embodiment, the organosiloxane composition comprises:
a) about 20 to about 55 wt. %, based on the total weight of the composition, of at least one polymerization-effective polymer bearing two or more silicon atoms;
b) about 24 to about 60 wt. %, based on the total weight of the composition, of a first filler of particle size from 0.1 μm to 10 μm;
c) optionally at least one second filler;
d) at least one crosslinking agent; and
e) at least one catalyst.

The organosiloxane composition includes a polymerization-effective polymer, which may be a monomer, pre-polymer, oligomer, copolymer, or polymer that can be polymerized or further polymerized or copolymerized. In one embodiment, the polymerization-effective polymer is a compound bearing two or more silicon atoms of the general formula (I):

M¹ₐM²_{b}M³_{c}M⁴_{d}D¹ₑD²_{f}D³_{g}D⁴ₕ (I)
wherein;
M¹=R¹R²R³SiO_{1/2}
M²=R⁴R⁵R⁶SiO_{1/2}
M³=R⁷R⁸R⁹SiO_{1/2}
M⁴=R¹⁰R¹¹R¹²SiO_{1/2}
D¹=R¹³R¹⁴SiO_{2/2}
D²=R¹⁵R¹⁶SiO_{2/2}
D³=R¹⁷R¹⁸SiO_{2/2}
D⁴=R¹⁹R²⁰SiO_{2/2}
where R¹ and R¹³ are each independently an aliphatic group having from 1 to 20 carbon atoms, preferably from 1 to about 8 carbon atoms, and more preferably from 1 to about 4 carbon atoms; an aromatic group having 6 to 30 carbon atoms, preferably 6 to 20 carbon atoms, and more preferably 6 to 10 carbon atoms; an OH group; —H; or OR²⁵ where R²⁵ is an aliphatic group or an aromatic group having from 1 to 20 carbon atoms, preferably from 1 to about 8 carbon atoms and more preferably from 1 to about 4 carbon atoms;
R², R³, R⁵, R⁶, R⁸, R⁹, R¹⁰ R¹¹, R¹², R¹⁴, R¹⁶, R¹⁸, R¹⁹ and R²⁰ are each independently an aliphatic group having from 1 to 20 carbon atoms, from 1 to about 8 carbon atoms, or from 1 to about 4 carbon atoms; an aromatic group having 6 to 30 carbon atoms, 6 to 20 carbon atoms, or 6 to 10 carbon atoms;
R⁴ and R¹⁵ are each independently of the formula:

—(CₙH₂ₙ)—O—(C₂H₄O)ₒ—(C₃H₆O)ₚ—(C₄H₈O)_{q}—R²⁶,
where R²⁶ is a hydrogen or an aliphatic group, or an aromatic group having from 1 to 20 carbon atoms, even more preferably from 1 to about 8 carbon atoms and most preferably from 1 to about 4 carbon atoms,
n is 0 to 6, and in some embodiments any one of 2, 3, or 4;
o is 0 to 100, preferably from about 1 to about 50, more preferably from 1 to about 30, or more preferably from about 1 to about 18;
p is 0 to 100, preferably 0 to about 50, more preferably from about 0 to about 30, or more preferably from about 0 to about 18;
q is 0 to 50, preferably 0 to about 18, more preferably from about 0 to about 8, or more preferably from about 0 to about 1;
500≥o+p+q≥0, more specifically provided o+p+q≥40, even more preferably o+p+q≥18 and most preferably o+p+q≥8;
R⁷ and R¹⁷ are each independently a branched, linear, or cyclic alkyl group, optionally saturated or unsaturated, having from 1 to 20 carbon atoms, 1 to 16, or 1 and the subscripts a, b, c, d, e, f, g, h are each independently zero or a positive integer, and provided that a+b+c+d+e+f+g+h≥2, preferably 2 to 30,000, more preferably 2 to 10,000 or more preferably 2 to 5,000;
a+b+c+d=2; and
a+e≥2.

The polymerization-effective polymer bearing two or more silicon atoms is a curable compound. In one embodiment, the polymerization-effective polymer is a condensation polymerization-effective polymer.

In one embodiment, the polymerization-effective polymer is a silanol, an alkoxy siloxane or combinations of two or more thereof. That is, in one embodiment, the polymerization-effective polymer bearing two or more silicon atoms is such that R¹ and R¹³ are each independently selected from —OH, —OR²⁵, and combinations thereof.

The polymerization-effective polymer is present in an amount of from about 20 to about 55 wt. % based on the total weight of the composition, preferably from about 30 wt. % to about 50 wt. %, or more preferably from about 35 wt. % to about 45 wt. % based on the total weight of the composition.

It will be appreciated that the composition can include two or more polymerization effective polymers of Formula (I) that differ in terms of chemical make up and/or in terms of size, viscosity, etc. In one embodiment, the composition includes a mixture of two or more polymerization effective polymers including:
a first polymerization effective polymer having a viscosity of from about 500 cps to about 500,000 cps; preferably from about 100 cps to about 100,000 cps; or more preferably from about 1000 cps to about 50,000 cps, the first polymerization effective polymer is present in an amount of from about 5 wt. % to about 50 wt. %; preferably from about 10 wt. % to about 40 wt. %; or more preferably from about 20 wt. % to about 30 wt. %; and
a second polymerization effective polymer having a viscosity of from about 1000 cps to about 100,000 cps; preferably from about 2000 cps to about 50,000 cps; or more preferably from about 3000 cps to about 30,000 cps, the second polymerization effective polymer is present in an amount of from about 0 wt. % to about 45 wt. %; preferably from about 10 wt. % to about 35 wt. %; or more preferably from about 15 wt. % to about 25 wt. %.
   wherein, viscosity is measured using a Brookfield viscometer, 25° C.±2, spindle #5, at 4 RPM. In one embodiment, the first and second polymerization effective polymers are each silanols.

The composition includes a first filler of discrete particle sizes and present in relatively large concentrations in the composition. The first filler may be chosen from treated or untreated clays, nano-clays, organo-clays, grounded calcium carbonate, precipitated calcium carbonate, colloidal calcium carbonate, calcium carbonate, aluminum silicates, treated aluminum silicates, talc, mica, pumice, wollastonite, dolomite, feldspar, or a combination of two or more thereof wherein treating agent(s) are selected from a stearate moiety or stearic acid, a surfactant, or a silane.

The first filler has an average particle size from about 0.1 μm to about 10 μm, from about 1 μm to about 8 μm, from about 2 μm to about 6 μm, or from about 2.5 μm to about 5 μm. Particle size may be evaluated or measured by methods such as static light scattering, dynamic light scattering, or via physical classification techniques such as the measurement of weight or volume fraction of solids retained on standardized test sieves such as ASTM sieve, X-ray sedimentation or laser diffractions.

The first filler is present in the composition in an amount of from about 24 wt. % to about 60 wt. % based on the total weight of the composition, from about 30 wt. % to about 50 wt. %, or from about 35 wt. % to about 45 wt. % based on the total weight of the composition. The filler increases the hardness of the composition. The amount of the first filler used in the composition is such that it renders the cured coating surface harder and more hydrophilic as compared to the silicone polymer, and prevents dust deposition and also enables wash-off of dust from the coating surface. Thus, the effective amount of the first filler to obtain this invention will be dictated by specific properties of the first filler such as particle size, aspect ratio, any surface treatments, or absence thereof. The amount of first filler is also dictated by the other specifications of the final product such a viscosity and elongation.

In an embodiment, the first filler is an untreated calcium carbonate or a treated calcium carbonate. In another embodiments where the first filler is a treated calcium carbonate, the calcium carbonate may be treated with compounds containing a stearate moiety, stearic acid, a surfactant, or a silane.

In another embodiment, the first filler is a silane-treated clay present in an amount of about 24 wt. % to about 60 wt. %, preferably from about 30 wt. % and about 50 wt. %, or more preferably from about 35 wt. % to about 40 wt. % based on the total weight of the composition.

In an embodiment, the composition may include any combination of the following for the first filler:
a treated filler material (i) having a particle size of from about 0.1 μm to about 10 μm; preferably from about 1 μm to about 8 μm; or about ≤5 μm; and
an untreated filler (ii) having a particle size of from about 0.1 μm to about 10 μm; preferably from about 1 μm to about 8 μm; or about ≤5 μm.

The present compositions optionally include at least one second filler. The second filler may be selected from a wide range of filler materials. Generally, the second filler is at least different from the first filler in terms of composition/filler type or has a particle size outside of the particle size of the first filler. Examples of suitable materials for the second filler include, but are not limited to, treated or untreated clays, nano-clays, organo-clays, ground calcium carbonate, precipitated calcium carbonate, colloidal calcium carbonate, treated calcium carbonate, talc, mica, pumice, wollastonite, dolomite, feldspar, nepheline syenite, barite, diatomite, calcite, fumed silica, precipitated silica, crushed quartz, ground quartz, alumina, aluminum hydroxide, ceramic and glass spheres, silicone resins, titanium dioxide, titanium hydroxide, hydroxide, kaolin, bentonite montmorillonite, diatomaceous earth, iron oxide, carbon black, graphite, or combinations of two or more thereof, wherein treating agent(s) are selected from a stearate moiety or stearic acid surfactants or silanes.

The second filler is present in the composition in an amount of from about 0 to about 20 wt. % of the total composition, preferably from about 1 wt. % to about 15 wt. %, more preferably from about 2 wt. % to about 10 wt. %, or even more preferably about 4 wt. % to about 8 wt. %.

In an embodiment, the composition comprises at least one catalyst to promote or catalyze polymerization and formation of the coating. The catalyst is not particularly limited and can be selected from any material suitable for catalyzing the polymerization of silicone polymers of the type described herein. A particularly suitable class of catalysts include metal condensation catalysts including, for example, those where the metal is selected from the group consisting of tin, titanium, zirconium, lead, iron cobalt, antimony, manganese, bismuth and zinc compounds.

In one embodiment, the catalyst is selected from dibutyltindilaurate, dibutyltindiacetate, dibutyltindimethoxide, tinoctoate, isobutyltintriceroate, dibutyltinoxide, solubilized dibutyl tin oxide, dibutyltin bis-diisooctylphthalate, 1,3-propanedioxytitanium bis(ethylacetoacetate), di-isopropoxytitanium bis(ethylacetoacetate), tetra n-butyl titanate, tetraisopropyl titanate, di-isopropyl titanium bisacetylacetonate, bis-tripropoxysilyl dioctyltin, dibutyltin bis-acetylacetone, silylated dibutyltin dioxide, carbomethoxyphenyl tin trisuberate, isobutyltin triceroate, dimethyltin dibutyrate, dimethyltin di-neodecanoate, triethyltin tartarate, dibutyltin dibenzoate, tin oleate, tin naphthenate, butyltintri-2-ethylhexylhexoate, and tin butyrate, and combinations thereof.

In one embodiment, the catalyst is a titanium based catalyst selected from 1,3-propanedioxytitanium bis(ethylacetoacetate), di-isopropoxytitanium bis(ethylacetoacetate), tetra n-butyl titanate, tetraisopropyl titanate, di-isopropyl titanium bisacetylacetonate and combinations thereof.

The composition further comprises at least one crosslinking agent. In one embodiment, the crosslinking agent is a compound of the general formula (II):

(R^{A})_{x″}R^{B}_{y″}Si (II)

wherein, R^{A} is independently selected from hydrogen or alkoxy group and R^{B} is independently chosen from a monovalent C1 to C⁶⁰ hydrocarbon radicals, such as, but not limited to, methyl, ethyl, propyl, isopropyl, butyl, tert-butyl, sec-butyl, etc., an epoxy group, a mercapto group, an acrylate group, a methacryloxy group, a vinyl group, an isocyanato group, an isocyanurate group, a carboxy group, an alkylthiocarboxylate group, an ureido group, a polyalkylene oxide group, an amino group, an amido group, a urea group having from 1 to 60 carbon atoms, and wherein x″ is from 2 to 4 and y″ is from 0 to 2, provided that x″+y″=4.

In one embodiment, the crosslinking agent is selected from the group consisting of alkoxy silane, epoxy silane, mercapto silane, acrylate silane, methacryloxy silane, vinyl silane, isocyanato silane, and combinations thereof.

In another embodiment, the one or more crosslinking agents are selected from isocyanato silane, N-(beta-aminoethyl)-γ-aminopropyltrimethoxysilane, N-ethyl-γaminoisobutyl trimethoxysilane, Bis[γ-(trimethoxysilyl)propyl]amine, n-2-aminoethyl-3-aminopropyltri-methoxysilane, 1,3,5-tris(trimethoxysilylpropyl)isocyanurate, γ-aminopropyltriethoxysilane, γ-aminopropyltrimethoxysilane, aminopropyltrimethoxy-silane, bis-γ-trimethoxysilylpropyl)amine, N-Phenyl-γ-aminopropyltrimethoxysilane, triaminofunctionaltrimethoxysilane, γ-aminopropyl-methyldiethoxysilane, γ-aminopropylmethyldiethoxysilane, methacryloxypropyltrimethoxy-silane, methylamino-propyltrimethoxysilane, γ-glycidoxypropylethyldimethoxysilane, γ-glycidoxypropyl-trimethoxysilane, γ-glycidoxyethyltrimethoxysilane, beta-(3,4-γepoxycyclohexyl)propyl-trimethoxysilane, beta-(3,4-epoxycyclohexyl)ethylmethyl-dimethoxy-silane, isocyanato-propyltriethoxysilane, isocyanatopropylmethyl-dimethoxysilane, beta-cyanoethyl-trimethoxysilane, γ-acryloxypropyltrimethoxysilane, γ-methacryloxypropylmethyl-dimethoxysilane, 4-amino-3,3-dimethylbutyltrimethoxy-silane, n-ethyl-3-trimethoxysilyl-2-methylpropanamine and Tris[3-(trimethoxysilyl)propyl] isocyanurate.

In another embodiment, the crosslinking agent is present in an amount of from about 0.5 wt. % to about 20 wt. %, preferably from about 2 wt. % to about 10 wt. %, or more preferably from 5 wt. % to about 15 wt. % based on the total weight of the composition.

The organosiloxane compositions may optionally comprise one or more additives as desired to provide a particular effect or impart a particular property to the resulting coating. Examples of suitable additives include, but are not limited to, pigments, biocides, processing aids, surfactants, preservatives, flow and levelling agents, microbicides, fungicides, algicides, nematodicites, molluscicides, matting agents, organic polymer particles, thixotropic additives, waxes, flame retardants, anti-stat agent, anti-sag agents, solvents, adhesion promoters, or combinations of two or more thereof.

The optional additive(s) is/are present in an amount of from about 0 wt. % to about 20 wt. %, preferably from about 2 wt. % to about 10 wt. %, or more preferably from 5 wt. % to about 15 wt. % based on the total weight of the composition

In one embodiment, one or more additives are selected from Bis(trifluoromethanesulfonimide) salt such as lithium salt, PTFE particles, titanium dioxide, silicon dioxide, PTFE, polyamides, polyolefins, silicone polyether, silicone polyesters, fluoropolyethers, fluoropolyester, fluorosilicones, polyacrylates, silicone acrylates, or combination thereof.

In one embodiment, the compositions include an adhesion promoter selected from an isocyanato silane. Some non-limiting examples of suitable isocyanato silanes include, but are not limited to, α-isocyanatomethyltrimethoxysilane, β-isocyanatoethyltrimethoxysilane, γ-isocyanatopropyltrimethoxysilane, α-isocyanatomethyltriethoxysilane, β-isocyanatoethyltriethoxysilane, 3-isocyanatopropyltrimethoxysilane, Tris[3-(trimethoxysilyl)propyl] isocyanurate and μ-isocyanatopropyltriethoxysilane, and combinations of two or more thereof.

Other non-limiting examples of adhesion promoters include, N-(beta-aminoethyl)-gamma-aminopropyltrimethoxysilane, N-ethyl-gammaaminoisobutyl trimethoxysilane, Bis-[gamma-(trimethoxysilyl)propyl]amine, Bis-[Gamma-(triethoxysilyl)propyl]amine, n-2-aminoethyl-3-aminopropyltrimethoxysilane, 1,3,5-tris(trimethoxysilylpropyl)isocyanurate, gamma-aminopropyltriethoxysilane, gamma-aminopropyltrimethoxysilane, aminopropyltrimethoxysilane, bis-gamma-trimethoxysilylpropyl)amine, N-Phenyl-gamma-aminopropyltrimethoxysilane, triaminofunctionaltrimethoxysilane, gamma-aminopropylmethyldiethoxysilane, gamma-aminopropylmethyldiethoxysilane, methacryloxypropyltrimethoxysilane, methylaminopropyltrimethoxysilane, gamma-glycidoxypropylethyldimethoxysilane, gamma-glycidoxypropyltrimethoxysilane, gamma-glycidoxyethyltrimethoxysilane, beta-(3,4-epoxycyclohexyl)propyltrimethoxysilane, beta-(3,4-epoxycyclohexyl)ethylmethyldimethoxysilane, isocyanatopropyltriethoxysilane, isocyanatopropylmethyldimethoxysilane, beta-cyanoethyltrimethoxysilane, gamma-acryloxypropyltrimethoxysilane, gamma-methacryloxypropylmethyldimethoxysilane, 4-amino-3,3-dimethylbutyltrimethoxysilane, n-ethyl-3-trimethoxysilyl-2-methylpropanamine, Tris[3-(trimethoxysilyl)propyl] isocyanurate and mixtures thereof.

In one embodiment, the present coating compositions may further contain from about 0.5 to about 40 percent, preferably about 1 to about 30 percent, more preferably about 5 to 25 percent, or even more preferably about 10 to about 20 percent by weight of a pigment based on the total weight of the coating composition. Pigments suitable for use in coating compositions are generally known in the art. Non-limiting examples of pigments are titanium dioxide, treated titanium dioxide, coated titanium dioxide, iron oxide, carbon black, graphite, metallic salts, ultramarines, quinacridone, magenta, phthalo green, phthalo blue, pigment red 170, diarylide yellow, etc., and combinations of two or more thereof.

In one embodiment, the present compositions of may also comprise organic polymer particles that fulfil a multitude of functions. The particles can be used as a wax wherein they act as thixotropic additives to prevent formulation sagging, especially when applied on to vertical or sloping surfaces. The organic polymer particles can also function as surface modifiers, wherein they migrate to the cured coating surface and provide properties such as stain resistance, abrasion resistance, mar resistance, and anti-blocking property. The particles can further be used as impermeability inducing aids to the composition.

In one embodiment, the composition includes an organic polymer that functions as a wax or thixotropic type of material. Examples of suitable materials for that function as a wax/thixotropic agent include, but are not limited to polyolefin wax, polyamide wax, polyfluoroorganic wax, carnauba wax, silicone-based wax and beeswax. In one embodiment, the wax/thixotropic agent is present in an amount of from about 0.5 wt. % to about 15 wt. %; preferably from about 2 wt. % to about 10 wt. %; or more preferably about 4 wt. % to about 8 wt. %. In one aspect, dirt pick-up resistance can be improved by employing a combination of the first filler and a wax/thixotropic agent.

In one embodiment, the compositions include a surfactant. Surfactants are used as additives to improve the dispersion of certain fillers in the liquid formulation, in addition to aiding in emulsification, compatibilization of components, leveling, flow and reduction of surface defects. Such further optional additives may also provide improvements in the cured or dry film, such as improved abrasion resistance, anti-blocking, hydrophilic, and hydrophobic properties.

It has also been observed that a combination of silicone polyether surfactants and higher filler concentration provides a surprising benefit of improving the overall cleanability and dirt pick-up resistance of the coating formulation. Examples of suitable silicone polyether surfactants include, but are not limited to silicone polyethylene oxide random copolymers, silicone polyethylene oxide linear block copolymers, silicone polyethylene oxide pendant block copolymers, silicone polypropylene oxide random copolymers, silicone polypropylene oxide linear block copolymers, silicone polypropylene oxide pendant block copolymers and combinations thereof. The silicone polyether surfactants, if employed, may be present in an amount of from about 0.1 wt. % to about 10 wt. %; preferably from about 0.2 wt. % to about 8 wt. %; or more preferably from about 0.5 wt. % to about 2 wt. %.

In one embodiment, the coating of the present invention contains anti-stat additives which are hygroscopic compounds that prevent electrostatic deposition of dust on the coating surface, thereby retaining the coating original appearance for a longer time. In an embodiment, the anti-stat agent is selected from bis(trifluoromethanesulfonimide) lithium salt, 1-Butyl-3-methylimidazolium tetrafluoroborate 1-Butyl-3-methylimidazolium hexafluorophosphate. When utilized, the anti-stat additive may be present in an amount of from about 100 to 2000 ppm, preferably from about 200 to about 1500, or more preferably from about 750 to 1500 ppm based on the total weight of the coating composition.

In an embodiment, the organosiloxane compositions as described herein comprise the first filler along with any combination of the following fillers and additives:
the second filler material;
an organic polymer particle;
a silicone polyether surfactant; and/or
an anti-stat additive.
   It will be appreciated that the above combinations can include any combination of materials as described herein. For example, the above includes combinations where the composition comprises a plurality of types of first filler material (e.g., a first filler of a first particle size (treated or untreated) and a first filler of a second particle size (treated or untreated), etc.).

The compositions may be formed in general by mixing the components. Typically, the polymer component(s) (i.e., the polymerization-effective silicone polymer,) are mixed together; the “solid” components, e.g., the fillers, optional additives, etc., are then added to the mixture; and subsequently the crosslinkers, adhesion promoters (if used), and catalyst are added to the mixture, which is allowed to equilibrate.

The compositions may be applied to a surface of a substrate of interest to form a coating. The substrate is not particularly limited and can be chosen from a variety of substrates including, but not limited to, concrete, plastic, metal, wood, fibrous, foam, bitumen, or any other surface. Generally, the coating is formed by moisture or condensation curing of the compositions. The moisture required to effect curing of the compositions can be applied by methods known to those skilled in the art including, but not limited to, simply exposing the surface coated with the curable composition to atmospheric moisture.

The amount of coating composition applied to a substrate can depend on several factors such as, but not limited to, the type of substrate, the temperature, the humidity, the specific parts of the coating composition, the desired coating thickness, etc. In one embodiment, the coating is applied in sufficient amount or thickness to provide a cured coating having a thickness of from about 0.1 mm to about 10 mm, from about 0.5 mm to about 5 mm, or from about 1 mm to about 2.5 mm.

In one or more embodiments, the coatings formed from the present compositions may have one or a combination of two or more of the following properties:
a Shore A durometer value per ASTM D2240 of from about 40 to about 70;
a tensile strength (measured as described herein) of from about 1.0 to about 2.0, from about 1.10 to about 1.60, or from about 1.12 to about 1.45;
an elongation (measured as described herein) of from about 100% to about 400%, from about 140% to about 360%, or from about 150% to about 350%.

The coating compositions can be applied to a surface substrate by any suitable method as desired. Examples of suitable methods for applying the coating compositions to a surface of a substrate include, but are not limited to those commonly known and used by those skilled in the art such as, for example, brushing, rolling, dipping, or spraying.

The compositions can be used in a variety of applications. In embodiments, the compositions can be employed as a coating, sealant, caulk, seam sealant or adhesive material which can be a single coat anti-dirt, anti-stain, anti-fouling coating material, roof coating, architectural coating, marine coating, or a protective coating.

In one embodiment, the present compositions may be employed to form a coating suitable for use as roof coatings, architectural coatings, OEM product coatings, coil coatings, or special purpose coatings, such as industrial maintenance coatings and marine anti-fouling coatings.

In one embodiment, the present invention may be directed to an architectural coating comprising the elastomeric coating composition as described herein. In another aspect, the present invention may be directed to a single coat anti-dirt, and/or anti-stain, and/or anti-fouling coating comprising the elastomeric coating composition as described herein.

In one embodiment, the elastomeric coating composition can be used as a coating that is other than that of a sealant or adhesive for treating a void, crack, joint, or other abscess in the architectural and/or construction field. Accordingly, the present invention may be directed to a coating of a minor amount (i.e., less than 50%) of the substrate surface or a major portion (i.e., greater than 50%) of a substrate surface, such as an architectural element or building façade, to provide for a paint-like coating of the substrate, and not a sealant used in filling or joining the any of abscesses described above or similar ones known to those of ordinary skill in the art.

As used herein the expression “architectural element” denotes a prefabricated or manufactured unit used in building construction, e.g., a window doors containing one or more windows, prefabricated windows, sliding doors with one or more windows, folding doors with one or more windows, curtain wall, shop glazing, structural glazing, a skylight, light fixtures, and the like, in which a bonding, bedding glaze, sealant, caulking or adhesive composition is used to bond the glazing to structural elements comprising the “architectural element”.

In one embodiment, the substrate can comprise any material that may be on the face of a building or structure that is sought to be waterproofed and/or weather protected, such as concrete, brick, wood, metal, plastic, stone, mortar, painted substrates, and the like.

In yet another embodiment, the elastomeric coating formed from the compositions can provide water proofing protection for a longer period of time than that of coating of an identical substrate, coated with an identical coating composition wherein only one of either filler (b) is present in the coating composition. Water proofing protection can comprise water impermeability. In one embodiment, the period of time can be such as that described for UV resistance.

In one embodiment, the elastomeric coating on the roof maintains the original solar reflectance index (SRI) of the roof substrate for a longer time period than that of an identical substrate coated with an identical coating composition having lower amount of filler.

Aspects and embodiments of the present compositions may be further understood with respect to the following examples. The examples are intended to illustrate embodiments and are not necessarily intended to limit the compositions to specific examples or embodiments.

### EXAMPLES

Organopolysiloxane compositions are prepared according to one of the following methods.

A. Laboratory Scale. Organopolysiloxane compositions are prepared in the laboratory using a high-speed mixer. The liquid components of the composition, viz silanol polymers (Momentive Performance Materials) additives and solvents were blended in a plastic container at 2000 RPM speed for 5 min. To this blend, the solid components comprising of fillers and optionally polymer particles, were added in 3 parts, with a mixing step of 5 min at 2000 RPM in between. Finally, the catalyst blend consisting of silane crosslinkers, adhesion promoters (Momentive Performance Materials) and a titanium chelate-based catalyst (E.g., Tyzor PITA from Dorf Ketal Chemicals) was added, and the mixtures was allowed to ‘equilibrate’ for a minimum of 7 days at room temperature in a closed container, prior to testing.

Bulk Methods. The composition can also be prepared in bulk using two methods. In the first method, the liquid components of the coating, viz silanol polymers (Momentive Performance Materials) additives and solvents were mixed in a double planetary mixer for 2 hrs at 50 RPM. To this blend, the solid components comprising of fillers and optionally polymer particles, were added in 3 parts, with a mixing step of 60 min at 50 RPM in between. Finally, the catalyst blend consisting of silane crosslinkers, adhesion promoters (Momentive Performance Materials) and a titanium chelate-based catalyst (E.g., Tyzor PITA, Dorf Ketal Chemicals) and the mixture were allowed to ‘equilibrate’ for a minimum of 7 days at room temperature in a closed container, prior to testing.

Viscosity of the compositions prepared in the various examples below are measured using Brookfield Model LV, 23° C.±2, Spindle S64, 50 RPM. or Brookfield viscometer, 25° C.±2, spindle #5, 4 RPM.

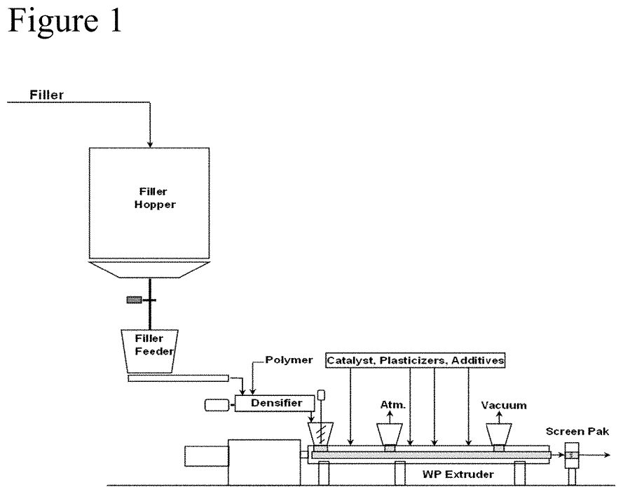

In the second method the composition is produced on a continuous way in a Coperian twin screw extruder as shown in FIG. 1.

The materials employed to form the compositions are identified in Table 1:

TABLE 1

| | |
|---|---|
| Silanol-terminated PDMS, | Momentive Performance Materials |
| 30,000 cps | |
| Silanol-terminated PDMS, | Momentive Performance Materials |
| 3000 cps | |
| Solvent (D5) | Momentive Performance Materials |
| Stearic acid treated | Mineral Specialties (5μ |
| Calcium Carbonate #1 | Average particle size |
| | determined by X-ray sedimentation) |
| Stearic acid treated | Omya (1.4μ |
| Calcium Carbonate #2 | average particle size |
| | determined by Laser Diffraction) |
| Untreated calcium | Imerys (2μ |
| carbonate #1 | Average particle size |
| | determined by X-ray sedimentation) |
| Untreated calcium | Omya (2μ |
| carbonate #2 | Average particle size |
| | determined by X-ray sedimentation) |
| Aluminosilicates with | Burgess (1.45 to 1.65μ |
| various surface | average particle size |
| treatments (specifically | determined by X-ray sedimentation) |
| mentioned in | |
| examples) | |
| Untreated aluminosilicates | Burgess (0.7μ |
| | average particle size |
| | determined by X-ray sedimentation) |
| Hydrophobized fumed silica | Evonik |
| Titanium dioxide | DuPont |
| Silquest A-link 597 | Momentive Performance Materials |
| Methyltrimethoxysilane | Momentive Performance Materials |
| Titanium catalyst | Dorf Ketal |
| Fluoro-organic microwax | Micropowders, Inc./Shamrock |
| Polyolefin microwax | Shamrock |
| Catalyst blend | Momentive Performance Materials |
| Antistatic agent | Sigma-Aldrich |

### Synthesis Example 1

All the polymers, fillers, additives, crosslinkers were added at the different stages (as shown in FIG. 1) in the continuous feeding process at the final output rate of 40-60 lbs./hrs. The mixtures so obtained were allowed to “equilibrate” for a minimum of 7 days at room temperature in a closed container, prior to testing.

TABLE 2
Example 1: Effect of filler loading

| Components | Ex 1.a | Ex 1.b | Ex. 1 Control |
|---|---|---|---|
| Silanol-terminated PDMS, | 8 | 6 | 10 |
| 30,000 cps | | | |
| Silanol-terminated PDMS, | 31 | 23 | 39 |
| 3000 cps | | | |
| Solvent | 8 | | |
| Stearic acid treated Calcium | | | |
| Carbonate #1 | 34 | 44 | 24 |

| | |
|---|---|
| Hydrophobized fumed silica | 5 |
| Titanium dioxide | 6 |
| Silquest A-link 597 | 0.92 |
| Methyltrimethoxysilane | 4.62 |
| Titanium catalyst | 2.46 |
| Total | 100 |

Properties

| | | | |
|---|---|---|---|
| Shore A Hardness | 60 | 65 | 42 |
| Shore A Hardness | 60 | 65 | 42 |
| dE, Iron Oxide | 5.3 | 4.9 | 4.76 |
| dE, Carbon black | 5.5 | 5.8 | 5.12 |
| dE, Lab DPUR | 13.46 | 12.47 | 16.8 |

As seen in Example 1 increasing the loading of CaCO₃ filler improved the dirt pick-up resistance of the coating formulation.

### Example 2

Compositions are prepared as indicated in Table 3. The compositions employ combinations of fillers of different particles sizes.

TABLE 3

| | Ex 2 | Ex | Ex | Ex | Ex | Ex |
|---|---|---|---|---|---|---|
| Components | Control | 2.a | 2.b | 2.c | 2.d | 2.e |
| Silanol-terminated | 10.00 | 7.00 | 7.00 | 7.00 | 7.00 | 7.00 |
| PDMS, 30,000 cP | | | | | | |
| Silanol-terminated | 39.00 | 27.00 | 27.00 | 27.00 | 27.00 | 27.00 |
| PDMS, 3000 cP | | | | | | |
| Solvent | 8.00 | 8.00 | 8.00 | 8.00 | 8.00 | 8.00 |
| Stearic acid treated | 24.00 | 33.00 | 22.00 | 11.00 | 0.00 | 44.00 |
| Calcium Carbonate # | | | | | | |
| 15 μm | | | | | | |
| Untreated Calcium | 0.00 | 11.00 | 22.00 | 33.00 | 44.00 | 0.00 |
| Carbonate # 2 | | | | | | |
| Hydrophobized fumed | 5.00 | 0.00 | 0.00 | 0.00 | 0.00 | 0.00 |
| silica | | | | | | |

| | |
|---|---|
| Titanium Dioxide | 6.00 |
| Silquest A-link 597 | 0.92 |
| Methyltrimthoxysilane | 4.62 |
| Titanium Catalyst | 2.46 |
| Total | 100 |

Properties

| | | | | | | |
|---|---|---|---|---|---|---|
| Elongation, % | 275% | 107% | 120% | 98% | 124% | 173% |
| Viscosity @ 50 RPM, | 4091 | 3731 | 5195 | 5771 | 9286 | 3323 |
| cP | | | | | | |
| dE, Lab DPUR | 20.41 | 17.95 | 8.88 | 7.68 | 6.67 | 14.43 |

As seen in Table 2, increasing the overall filler composition had a general effect of improving DPUR of the formulation but has reverse effect on percentage elongation at break. The effect was more prominent with a lower particle size of the filler and increased with increasing content of smaller particle size. Thus, the particle size and ratio can be optimized to give desired coating mechanical properties along with DPUR enhancement.

### Example 3

Compositions are prepared employing a fluoro-organic microwax. The compositions under this example are shown in Table 4.

TABLE 4

| Component | Ex 3. Control | Ex 3. Control a | Ex 3.b |
|---|---|---|---|
| Silanol-terminated | 10 | 10 | 7 |
| PDMS 30,000 cP | | | |
| Silanol-terminated | 39 | 39 | 28 |
| PDMS 3000 cP | | | |
| Solvent | 8 | 7 | 7 |
| Stearic acid treated | 24 | 15 | 26 |
| calcium carbonate #1 | | | |
| 5 μm | | | |
| Fluoro-organic | 0 | 9 | 14 |
| microwax #1 | | | |
| Hydrophobized fumed | 5 | 6 | 5 |
| silica | | | |
| Titanium dioxide | 6 | 6 | 5 |
| Silquest A link 597 | 0.92 | 0.92 | 1.44 |
| Methyltrimethoxysilane | 4.62 | 4.62 | 4.096 |
| Titanium catalyst | 2.46 | 2.46 | 2.464 |
| Total | 100 | 100 | 100 |

Properties

| | | | |
|---|---|---|---|
| Shore A Hardness | 42 | 48 | 55 |
| dE, 60 day Exterior DPUR | 16.8 | 9.8 | 8.84 |
| dE, Carbon black | 5.9 | 3.9 | 1.21 |
| dE, Iron Oxide | 4 | 2.6 | 0.47 |

As seen in Table 4, increasing the loading of Fluoro-organic microwax had a dramatic improvement on the coating's hardness and clean-ability. It also reduced the amount of dirt deposition upon exposure to exterior environment.

### Example 4

The compositions prepared under this example illustrate the effect of different fillers and fluoro-organic microwax. The compositions are set forth in Table 5.

TABLE 5

| | Ex 4. | | | | | | |
|---|---|---|---|---|---|---|---|
| Component | Control | Ex 4.a | Ex 4.b | Ex 4.c | Ex 4.d | Ex 4.e | Ex 4.f |
| Silanol-terminated PDMS | 17.50 | 7.80 | 7.00 | 6.78 | 6.78 | 17.50 | 17.50 |
| 30000 cP | | | | | | | |
| Silanol-terminated PDMS | 28.70 | 22.90 | 19.70 | 18.92 | 18.92 | 28.70 | 28.70 |
| 3000 cP | | | | | | | |
| Stearic acid treated Calcium | 26.20 | 0.00 | 0.00 | 0.00 | 0.00 | | |
| Carbonate # 1 | | | | | | | |
| Untreated calcium carbonate | 0.00 | 40.00 | 0.00 | 0.00 | 0.00 | 0.00 | 0.00 |
| # 1 | | | | | | | |
| Stearic acid treated Calcium | 0.00 | 0.00 | 44.00 | 40.00 | 40.00 | 24.7 | 24.7 |
| carbonate # 2 | | | | | | | |
| Hydrophobized fumed silica | 3.50 | 0.00 | 0.00 | 0.00 | 0.00 | 4.00 | 4.00 |
| Fluoro-organic microwax #2 | 0.00 | 0.00 | 0.00 | 0.00 | 8.00 | 0.00 | 8.00 |
| Polyolefin microwax | 0.00 | 0.00 | 0.00 | 5.00 | 0.00 | 5.00 | 0.00 |
| Solvent | 6.70 | 8.00 | 8.00 | 8.00 | 8.00 | 6.70 | 6.70 |
| Titanium dioxide | 11.10 | 13.30 | 13.30 | 13.30 | 13.30 | 11.10 | 11.10 |
| 45% blend in 30000 cP | | | | | | | |
| silanol-terminated PDMS | | | | | | | |
| Catalyst blend | 6.30 | 8.00 | 8.00 | 8.00 | 8.00 | 6 | 6 |
| Total | 100.00 | 100.00 | 100.00 | 100.00 | 103.00 | 104.00 | 107.00 |

Properties

| | | | | | | | |
|---|---|---|---|---|---|---|---|
| Viscosity with Spindle #5 | 21,700 | 30,900 | 38,500 | >100,000 | 43,700 | 54,600 | 30,400 |
| @4 RPM | | | | | | | |
| Sag Resistance | 60 | 60 | 60 | 60 | 60 | 60 | 60 |
| Weight % Solids | 92.2 | 91.0 | 90.1 | 92.9 | 92.0 | 93.4 | 93.2 |
| Hiding Power | ok | ok | ok | ok | ok | ok | ok |
| Shore A Hardness | 32 | 51 | 51 | 51 | 51 | 38 | 39 |
| Cleanability | 31.58 | 22.7 | 23.8 | 27.05 | 26.55 | 22.71 | 21.93 |
| Iron oxide dE | | | | | | | |
| Cleanability with soap | 12.44 | 11.21 | 12.58 | 13.48 | 13.74 | 10.21 | 9.42 |
| solution | | | | | | | |
| Iron oxide after soap dE | | | | | | | |
| Cleanability | 32.78 | 28.93 | 18.62 | 29.5 | 22.18 | 15.04 | 23.82 |
| Carbon Black dE | | | | | | | |
| Cleanability with soap | 12.54 | 8.85 | 5.69 | 10.18 | 8.48 | 4.64 | 7.97 |
| solution | | | | | | | |
| Carbon Black dE | | | | | | | |
| Lab DPUR, dE | 21.5 | 14 | 13.8 | 14.1 | 14.68 | 20 | 20 |
| Exterior DPUR (120 day), | 7.21 | 5.11 | 6.52 | 5.52 | 5.17 | 7.28 | 6.5 |
| dE | | | | | | | |

### Example 5: Effect of Anti-Stat Additive

A control silicone coating formulation was prepared with a composition as per Ex. 1 Control. The anti-static additive Bis(trifluoromethanesulfonimide) lithium salt was dissolved in THF to prepare a 1% stock solution. This stock solution was added to the control formulation such that the anti-static additive was present in 100 ppm to 500 ppm final loading. The coatings were cured as described and tested.

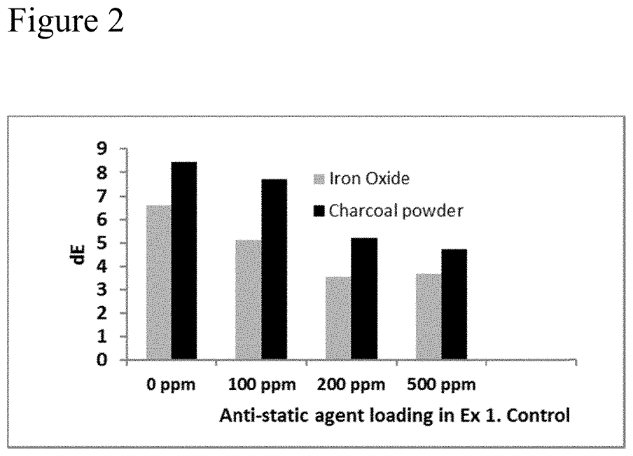

As seen from the graph in FIG. 2, there was a clear improvement in the clean-ability of the silicone coating formulation as result of anti-static additive incorporation.

### Example 6

This set of examples illustrate the effect of employing a filler and anti-stat additive. The compositions for this set of examples are set forth in Table 6.

TABLE 6

| | | | | | | Ex 6. |
|---|---|---|---|---|---|---|
| Component | Ex 6.a | Ex 6.b | Ex 6.c | Ex 6.d | Ex 6.e | Control |
| CRTV 942 30K | 8 | 8 | 8 | 8 | 8 | 10 |
| Silanol | | | | | | |
| CRTV944 3K Silanol | 31 | 31 | 31 | 31 | 31 | 39 |
| SF 1202 (D5) | 8 | 8 | 8 | 8 | 8 | 8 |
| Stearic acid treated | 34 | 34 | 34 | 34 | 34 | 24 |
| Calcium carbonate #1 | | | | | | |
| Treated filler (fumed | 5 | 5 | 5 | 5 | 5 | 5 |
| silica by HMDZ) | | | | | | |
| TiO₂ | 6 | 6 | 6 | 6 | 6 | 6 |
| Catalyst | 8 | 8 | 8 | 8 | 8 | 8 |
| Total | 100 | 100 | 100 | 100 | 100 | 100 |
| Antistatic loading, | 1500 | 1000 | 750 | 500 | 0 | 0 |
| ppm | | | | | | |

Properties

| | | | | | | |
|---|---|---|---|---|---|---|
| Viscosity @ 50 RPM, | 4211 | 4523 | 4655 | 4895 | 5351 | 4055 |
| cP | | | | | | |
| Shore A Hardness | 51 | 55 | 50 | 50 | 50 | 50 |
| Cleanability | 3.0 | 3.6 | 3.8 | 6.0 | 4.1 | 4.5 |
| Iron Oxide, dE | | | | | | |
| Cleanability | 3.5 | 7.7 | 6.0 | 8.6 | 7.5 | 5.4 |
| Carbon black, dE | | | | | | |
| Lab DPUR, dE | 9.5 | 10.5 | 11.2 | 14.4 | 18.4 | 16.2 |

As seen, a combination of anti-static agent and high filler is more effective in improving coating clean-ability and DPUR, than that of a higher filler alone.

### Example 7: Effect of Surface Active Surfactant and Wax Additives

TABLE 7

| | Ex 7. | Ex 7. | Ex 7. | Ex 7. | Ex 7. | Ex 7. | Ex 7. | Ex 7. | Ex 7. | Ex 7. | Ex 7. |
|---|---|---|---|---|---|---|---|---|---|---|---|
| Component | a | b | c | d | e | f | g | h | i | j | Control |
| CRTV 942 | 10 | 10 | 10 | 10 | 10 | 10 | 10 | 10 | 10 | 10 | 10 |
| 30K,Cps Silanol | | | | | | | | | | | |
| CRTV944 3K, | 39 | 39 | 39 | 39 | 39 | 39 | 39 | 39 | 39 | 39 | 39 |
| Cps Silanol | | | | | | | | | | | |
| SF 1202 (D5) | 8 | 8 | 8 | 8 | 8 | 8 | 8 | 8 | 8 | 8 | 8 |
| Stearic acid | 24 | 24 | 24 | 24 | 24 | 24 | 24 | 24 | 24 | 24 | 24 |
| treated Calcium | | | | | | | | | | | |
| carbonate # 1 | | | | | | | | | | | |
| Treated filler | 5 | 5 | 5 | 5 | 5 | 5 | 5 | 5 | 5 | 5 | 5 |
| (fumed silica by | | | | | | | | | | | |
| HMDZ) | | | | | | | | | | | |
| TiO₂ | 6 | 6 | 6 | 6 | 6 | 6 | 6 | 6 | 6 | 6 | 6 |
| Catalyst | 8 | 8 | 8 | 8 | 8 | 8 | 8 | 8 | 8 | 8 | 8 |
| Total | 100 | 100 | 100 | 100 | 100 | 100 | 100 | 100 | 100 | 100 | 100 |
| Epoxy functional | 0.5 | 1 | | | | | | | | | |
| PDMS % | | | | | | | | | | | |
| Polyether silicone | | | 0.5 | 1 | | | | | | | |
| surfactant % | | | | | | | | | | | |
| Polyethylene Wax | | | | | 4 | 8 | | | | | |
| additive % | | | | | | | | | | | |
| Wax Alloy | | | | | | | 4 | 8 | | | |
| additive % | | | | | | | | | | | |
| Mixture of wax | | | | | | | | | 4 | 8 | |
| alloy additive % | | | | | | | | | | | |

Properties

| | | | | | | | | | | | |
|---|---|---|---|---|---|---|---|---|---|---|---|
| lab DPUR test dE | 13.46 | 19.07 | 17.32 | 15.11 | 18.21 | 15.63 | 17.21 | 19.58 | 17.21 | 15.15 | 21.47 |

### Example 8: Effect of Treated and Untreated Aluminum Silicate (Clay) Filler

TABLE 8

| | 8.a | | | | | |
|---|---|---|---|---|---|---|
| Components | Control | 8.b | 8.c | 8.d | 8.e | 8.f |
| Silanol-terminated PDMS 30,000 cps | 17.68 | 15.68 | 15.68 | 15.68 | 15.68 | 17.22 |
| Silanol-terminated PDMS 3000 cps | 35.15 | 31.18 | 31.18 | 31.18 | 31.18 | 34.25 |
| Solvent | 6.77 | 7.17 | 7.17 | 7.17 | 7.17 | 7.87 |
| Stearic acid treated Calcium | 24.95 | 0.00 | 0.00 | 0.00 | 0.00 | 0.00 |
| carbonate # 1 | | | | | | |
| Hydrophobized fumed silica | 4.04 | 0.00 | 0.00 | 0.00 | 0.00 | 0.00 |
| @Vinyl silane treated Aluminum | 0.00 | 35.84 | 0.00 | 0.00 | 0.00 | 0.00 |
| silicate 1 | | | | | | |
| @Silicone treated Aluminum silicate | 0.00 | 0.00 | 0.00 | 35.84 | 0.00 | 0.00 |
| 2 | | | | | | |
| @Silane treated Aluminum silicate 3 | 0 | 0.00 | 0.00 | 0.00 | 35.84 | 0.00 |
| $Calcined Aluminum silicate 4 | 0.00 | 0.00 | 35.84 | 0.00 | 0.00 | 29.53 |
| Titanium Dioxide | 5.05 | 4.48 | 4.48 | 4.48 | 4.48 | 4.92 |
| Titanium Catalyst | 6.36 | 5.65 | 5.65 | 5.65 | 5.65 | 6.20 |
| Total | 100.00 | 100.00 | 100.00 | 100.00 | 100.00 | 100.00 |
| Viscosity, Cps | 15400 | 14000 | 74100 | 17400 | 20100 | 31200 |
| (Viscosity with Spindle #5 @4 | | | | | | |
| RPM) | | | | | | |
| Tack Free Time, minutes | 40.00 | 50.00 | 70.00 | 40.00 | 45.00 | 70.00 |
| Tensile, psi | 178.00 | 280.00 | 234.00 | 251.00 | 268.00 | 264.00 |
| Elongation, % | 101.00 | 48.00 | 90.00 | 60.00 | 49.00 | 122.00 |
| Shore A | 40.00 | 59.00 | 51.00 | 56.00 | 61.00 | 47.00 |
| Lab DPUR Dirt Test, dE | 21.49 | 17.71 | 11.99 | 17.15 | 15.50 | 15.48 |

As can be seen from the DPUR results that all of the fillers had improved dirt pick-up properties and even better with increasing concentration of the fillers.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a curable composition suitable for use in providing a coating. Modifications may occur to those skilled in the art and to those who may make and use the invention. The disclosed embodiments are merely for illustrative purposes and not intended to limit the scope of the invention or the subject matter set forth in the claims. While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims. It is also anticipated that advances in science and technology will make equivalents and substitutions possible that are not now contemplated by reason of the imprecision of language and these variations should also be construed where possible to be covered by the appended claims.

1. An organosiloxane composition, comprising:
a) about 20 to about 55 wt. %, based on the total weight of the composition, of at least one polymerization-effective polymer bearing two or more silicon atoms;
b) about 24 to about 60 wt. %, based on the total weight of the composition, of at least one first filler having an average particle size from about 0.1 μm to about 10 μm;
c) optionally at least one second filler;
d) at least one crosslinking agent; and
e) at least one catalyst.

2. The organosiloxane composition of claim 1, wherein the polymerization-effective polymer bearing two or more silicon atoms is of the general formula (I):
M¹ₐM²_{b}M³_{c}M⁴_{d}D¹ₑD²_{f}D³_{g}D⁴ₕ (I)
wherein;
M¹=R¹R²R³SiO_{1/2}
M²=R⁴R⁵R⁶SiO_{1/2}
M³=R⁷R⁸R⁹SiO_{1/2}
M⁴=R¹⁰R¹¹R¹²SiO_{1/2}
D¹=R¹³R¹⁴SiO_{2/2}
D²=R¹⁵R¹⁶SiO_{2/2}
D³=R¹⁷R¹⁸SiO_{2/2}
D⁴=R¹⁹R²⁰SiO_{2/2}
where R¹ and R¹³ are each independently an aliphatic group having from 1 to 20 carbon atoms; an OH group; —H; or OR²⁵ where R²⁵ is an aliphatic group or an aromatic group having from 1 to 20 carbon atoms;
R², R³, R⁵, R⁶, R⁸, R⁹, R¹⁰ R¹¹, R¹², R¹⁴, R¹⁶, R¹⁸, R¹⁹ and R²⁰ are each independently an aliphatic group having from 1 to 20 carbon atoms; or an aromatic group having from 6 to 30 carbon atoms;
R⁴ and R¹⁵ are each independently of the formula:
—(CₙH₂ₙ)—O—(C₂H₄O)ₒ—(C₃H₆O)ₚ—(C₄H₈O)_{q}—R²⁶,
wherein R²⁶ is a hydrogen or an aliphatic group, or an aromatic group having from 1 to 20 carbon atoms;
n is 0 to 6;
o is 0 to 100;
p is 0 to 100;
q is 0 to 50;
o+p+q≥0, more specifically provided o+p+q≥40, even more preferably o+p+q≥18 and most preferably o+p+q≥8;
R⁷ and R¹⁷ are each independently a branched, linear, or cyclic alkyl group, optionally saturated or unsaturated, having from 1 to 20 carbon atoms, and the subscripts a, b, c, d, e, f, g and h are each independently zero or a positive integer, and provided that a+b+c+d+e+f+g+h≥2;
a+b+c+d=2; and
a+e≥2.

3. The organosiloxane composition of claim 2, wherein, the polymer of formula (I) contains at least one group chosen from —OH, —OR²⁵ or combinations thereof.

4. The organosiloxane composition of claim 1, wherein the at least one first filler is selected from the group consisting of treated or untreated clays, nano-clays, organo-clays, grounded calcium carbonate, precipitated calcium carbonate, colloidal calcium carbonate, treated calcium, silanes, talc, mica, pumice, wollastonite, dolomite, feldspar, nepheline syenite, barite, diatomite, calcite and combinations thereof.

5. The organosiloxane composition of claim 4, wherein, the at least one first filler is untreated calcium carbonate or a treated calcium carbonate.

6. The organosiloxane composition of claim 1, wherein, the at least one first filler has an average particle size of about 1 μm to about 8 μm.

7. The organosiloxane composition of claim 1, wherein, the optional at least one second filler is selected from the group consisting of treated or untreated clays, nano-clays, organo-clays, grounded calcium carbonate, precipitated calcium carbonate, colloidal calcium carbonate, treated calcium carbonate, talc, mica, pumice, wollastonite, dolomite, feldspar, nepheline syenite, barite, diatomite, calcite, fumed silica, precipitated silica, crushed quartz, ground quartz, alumina, aluminum hydroxide, ceramic and glass spheres, silicone resins, titanium dioxide, titanium hydroxide, hydroxide, kaolin, bentonite montmorillonite, diatomaceous earth, iron oxide, carbon black and graphite and combinations thereof.

8. The organosiloxane composition of claim 1, wherein the at least one catalyst is a metal condensation catalyst wherein the metal is selected from the group consisting of tin, titanium, zirconium, lead, iron cobalt, antimony, manganese, bismuth and zinc compounds.

9. The organosiloxane composition of claim 1, wherein the at least one catalyst is selected from the group consisting of dibutyltindilaurate, dibutyltindiacetate, dibutyltindimethoxide, tinoctoate, isobutyltintriceroate, dibutyltinoxide, solubilized dibutyl tin oxide, dibutyltin bis-diisooctylphthalate, 7. 1,3-propanedioxytitanium bis(ethylacetoacetate), di-isopropoxytitanium bis(ethylacetoacetate), tetra n-butyl titanate, tetraisopropyl titanate, di-isopropyl titanium bisacetylacetonate, bis-tripropoxysilyl dioctyltin, dibutyltin bis-acetylacetone, silylated dibutyltin dioxide, carbomethoxyphenyl tin trisuberate, isobutyltin triceroate, dimethyltin dibutyrate, dimethyltin di-neodecanoate, triethyltin tartarate, dibutyltin dibenzoate, tin oleate, tin naphthenate, butyltintri-2-ethylhexylhexoate, and tin butyrate, combinations thereof.

10. The organosiloxane composition of any of claim wherein the catalyst is selected from the group consisting of 1,3-propanedioxytitanium bis(ethylacetoacetate), di-isopropoxytitanium bis(ethylacetoacetate), tetra n-butyl titanate, tetraisopropyl titanate, di-isopropyl titanium bisacetylacetonate and combinations thereof.

11. The organosiloxane composition of any of claim 140, wherein the at least one crosslinking agent is of general formula (II):
(R^{A})_{x″}R^{B}_{y″}Si (II)
wherein, R^{A} is independently chosen from hydrogen or an alkoxy group and R^{B} is independently chosen from a monovalent C1 to C60 hydrocarbon radical, an epoxy group, a mercapto group, an acrylate group, a methacryloxy group, a vinyl group, an isocyanato group, an isocyanurate group, a carboxy group, an alkylthiocarboxylate group, an ureido group, a polyalkylene oxide group, an amino group, an amido group, a urea group having from 1 to 60 carbon atoms, and wherein x″ is from 2 to 4 and y″ is from 0 to 2, provided that x″+y″=4.

12. The organosiloxane composition of claim 11, wherein, the at least one crosslinking agent is selected from the group consisting of isocyanato silane, N-(beta-aminoethyl)-γ-aminopropyltrimethoxysilane, N-ethyl-γaminoisobutyl trimethoxysilane, Bis-[γ-(trimethoxysilyl)propyl]amine, n-2-aminoethyl-3-aminopropyltri-methoxysilane, 1,3,5-tris(trimethoxysilylpropyl)isocyanurate, γ-aminopropyltriethoxysilane, γ-aminopropyltrimethoxysilane, aminopropyltrimethoxy-silane, bis-γ-trimethoxysilylpropyl)amine, N-Phenyl-γ-aminopropyltrimethoxysilane, triaminofunctionaltrimethoxysilane, γ-aminopropyl-methyldiethoxysilane, γ-aminopropylmethyldiethoxysilane, methacryloxypropyltrimethoxy-silane, methylamino-propyltrimethoxysilane, γ-glycidoxypropylethyldimethoxysilane, γ-glycidoxypropyl-trimethoxysilane, γ-glycidoxyethyltrimethoxysilane, beta-(3,4-γepoxycyclohexyl)propyl-trimethoxysilane, beta-(3,4-epoxycyclohexyl)ethylmethyl-dimethoxy-silane, isocyanato-propyltriethoxysilane, isocyanatopropylmethyl-dimethoxysilane, beta-cyanoethyl-trimethoxysilane, γ-acryloxypropyltrimethoxysilane, γ-methacryloxypropylmethyl-dimethoxysilane, 4-amino-3,3-dimethylbutyltrimethoxy-silane, n-ethyl-3-trimethoxysilyl-2-methylpropanamine and Tris[3-(trimethoxysilyl)propyl] isocyanurate.

13. The organosiloxane composition of claim 1 further comprising one or more additives selected from the group consisting of pigments, biocides, processing aids, surfactants, preservatives, flow and levelling agents, microbicides, fungicides, algicides, nematicides, molluscicides, matting agents, organic polymer particles, thixotropic additives, waxes, flame retardants, anti-stat agent, anti-sag agents, solvents, adhesion promoters and combinations thereof.

14. The organosiloxane composition of claim 13, wherein one or more additives are selected from the group consisting of Bis(trifluoromethanesulfonimide) salt, PTFE particles, titanium dioxide, silicon dioxide, PTFE, polyamides, polyolefins, silicone polyether, silicone polyesters, fluoropolyethers, fluoropolyester, fluorosilicones, polyacrylates, silicone acrylates, or combination thereof.

15. An article comprising the organosiloxane composition of claim 1 disposed on at least a portion of a surface of the article.

16. The article of claim 15, wherein the composition is cured to form a coating, sealant, caulk, seam sealant, or adhesive material.

17. The article of claim 15, wherein the composition provides a roof coating, an architectural coating, a marine coating.

18. The article of claim 15, wherein the composition provides a anti-dirt coating, anti-stain coating, anti-fouling coating, an anti-corrosion coating, or a protective coating.

19. A process for forming a coating from the organosiloxane composition of any of claims 1-14 comprising:
(i) mixing the at least one polymerization-effective polymer (a) with the filler (b) and optional filler (c);
(ii) mixing the at least one crosslinking agent (d) and at least one catalyst (e) with the mixture of (i); and
(iii) curing the mixture from (ii) to form a coating.

20. The process of claim 19, wherein the process is a batch process.

21. The process of claim 19, wherein the process is conducted via an extrusion process.
